(19) United States
(12) Patent Application Publication
(10) Pub. No.: US 2021/0166649 A1
(43) Pub. Date: Jun. 3, 2021

(54) PIXEL DRIVING CIRCUIT AND LIQUID CRYSTAL DISPLAY PANEL

(71) Applicant: WUHAN CHINA STAR OPTOELECTRONICS SEMICONDUCTOR DISPLAY TECHNOLOGY CO., LTD., Wuhan, Hubei (CN)

(72) Inventor: Sikun HAO, Wuhan, Hubei (CN)

(21) Appl. No.: 16/770,990

(22) PCT Filed: Dec. 10, 2019
(86) PCT No.: PCT/CN2019/124177

§ 371 Date: Jun. 9, 2020

(30) Foreign Application Priority Data
Nov. 28, 2019 (CN) 201911191356.7

(51) Int. Cl. G09G 3/36; G02F 1/1343; G02F 1/1362

(52) U.S. Cl. CPC G09G 3/3688; G09G 3/3677; G02F 1/136286; G02F 1/136213; G02F 1/134309

(57) ABSTRACT

A pixel driving circuit and a liquid crystal display panel are proposed. The pixel driving circuit includes a first transistor, a second transistor and a third transistor. Gates of the first transistor, the second transistor and the third transistor are electrically connected to a scan line, an electrode of the first transistor is electrically connected to a first electrode of the second transistor, and a second electrode of the second transistor is electrically connected to a first electrode of the third transistor. The second electrode of the third transistor is connected to the first common electrode such that a voltage difference between the main sub-pixel unit and the subsidiary sub-pixel unit could exist when the voltage signal flows through the first transistor, the second transistor, and the third transistor. This increases the aperture rate of the display panel and avoids the parasitic capacitance and thus the display effect is improved.

### CROSS REFERENCE

This application claims the priority of Chinese Patent Application No. 201911191356.7, entitled “PIXEL DRIVING CIRCUIT AND LIQUID CRYSTAL DISPLAY PANEL”, filed on Nov. 28, 2019, the disclosure of which is incorporated herein by reference in its entirety.

### FIELD OF THE INVENTION

The present invention relates to a display field, and more particularly, to a pixel driving circuit and a liquid crystal display (LCD) panel.

### BACKGROUND OF THE INVENTION

The LCD panel changes the direction of the liquid crystals through the driving voltages such that a desired image could be shown from the refracted light. The vertical alignment (VA) LCD panel is widely used because of its higher contrast. However, the VA LCD panel has an issue of severe color cast. In order to solve this issue, the LCD panel divides the light area of the sub-pixel into multiple domains and controls the rotation angle of the liquid crystals in different domains to be different. However, this solution reduces the aperture rate of the display panel and introduces parasitic capacitance and thus the display effect is ruined.

Therefore, the conventional LCD panel has a technical issue of a low aperture rate due to the solution of the color cast, which affects the display effect.

### SUMMARY OF THE INVENTION

One objective of an embodiment of the present invention is to provide a pixel driving circuit and a LCD panel, to solve the above-mentioned issue of a low aperture rate, which affects the display effect.

According to an embodiment of the present invention, a pixel driving circuit is disclosed. The pixel driving circuit comprises a plurality of scan lines and a plurality of data lines. The plurality of scan lines and the plurality of data lines define a plurality of sub-pixel units. One of the plurality of sub-pixel units connected to a scan line and a data line. The sub-pixel unit comprises: a first common electrode; a main sub-pixel unit, comprising a first transistor, a first storage capacitor and a first liquid crystal capacitor; a subsidiary sub-pixel unit, comprising a second transistor, a second storage capacitor and a second liquid crystal capacitor; a third transistor, having a second electrode electrically connected to a first common electrode; wherein gates of the first transistor, the second transistor and the third transistor are electrically connected to a scan line, an electrode of the first transistor is electrically connected to a first electrode of the second transistor, and a second electrode of the second transistor is electrically connected to a first electrode of the third transistor.

In the pixel driving circuit, a first electrode of the first transistor is electrically connected to the data line, and a second electrode of the first transistor is electrically connected to the first electrode of the second transistor.

In the pixel driving circuit, the first transistor and the first storage capacitor are connected in series, and the first transistor and the first liquid crystal capacitor are connected in series.

In the pixel driving circuit, a first plate of the first storage capacitor is electrically connected to the second electrode of the first transistor, and a second plate of the first storage capacitor is electrically connected to the first common electrode.

In the pixel driving circuit, the pixel driving circuit further comprises a second common electrode. A first plate of the first liquid crystal capacitor is electrically connected to the second electrode of the first transistor, and a second plate of the first liquid crystal capacitor is electrically connected to the second common electrode.

In the pixel driving circuit, the second transistor and the second storage capacitor are connected in series, and the second transistor and the second liquid crystal capacitor are connected in series.

In the pixel driving circuit, a first plate of the second storage capacitor is electrically connected to the second electrode of the second transistor, and a second plate of the second storage capacitor is electrically connected to a first common electrode.

In the pixel driving circuit, a first plate of the second liquid crystal capacitor is electrically connected to the second electrode of the second transistor, and a second plate of the second liquid crystal capacitor is electrically connected to the second common electrode.

In the pixel driving circuit, a first electrode of the first transistor is electrically connected to the data line, a first electrode of the second electrode is electrically connected to the data line, and the first electrode of the first transistor is electrically connected to the first electrode of the second transistor.

In the pixel driving circuit, the main sub-pixel unit comprises four domains and the subsidiary sub-pixel unit comprises four domains.

According to an embodiment of the present invention, a liquid crystal display panel having a pixel driving circuit is disclosed. The pixel driving circuit comprises a plurality of scan lines and a plurality of data lines. The plurality of scan lines and the plurality of data lines define a plurality of sub-pixel units. One of the plurality of sub-pixel units connected to a scan line and a data line. The sub-pixel unit comprises: a first common electrode; a main sub-pixel unit, comprising a first transistor, a first storage capacitor and a first liquid crystal capacitor; a subsidiary sub-pixel unit, comprising a second transistor, a second storage capacitor and a second liquid crystal capacitor; a third transistor, having a second electrode electrically connected to a first common electrode; wherein gates of the first transistor, the second transistor and the third transistor are electrically connected to a scan line, an electrode of the first transistor is electrically connected to a first electrode of the second transistor, and a second electrode of the second transistor is electrically connected to a first electrode of the third transistor.

In the liquid crystal display panel, a first electrode of the first transistor is electrically connected to the data line, and a second electrode of the first transistor is electrically connected to the first electrode of the second transistor.

In the liquid crystal display panel, the first transistor and the first storage capacitor are connected in series, and the first transistor and the first liquid crystal capacitor are connected in series.

In the liquid crystal display panel, a first plate of the first storage capacitor is electrically connected to the second electrode of the first transistor, and a second plate of the first storage capacitor is electrically connected to the first common electrode.

In the liquid crystal display panel, the pixel driving circuit further comprises a second common electrode. A first plate of the first liquid crystal capacitor is electrically connected to the second electrode of the first transistor, and a second plate of the first liquid crystal capacitor is electrically connected to the second common electrode.

In the liquid crystal display panel, the second transistor and the second storage capacitor are connected in series, and the second transistor and the second liquid crystal capacitor are connected in series.

In the liquid crystal display panel, a first plate of the second storage capacitor is electrically connected to the second electrode of the second transistor, and a second plate of the second storage capacitor is electrically connected to a first common electrode.

In the liquid crystal display panel, a first plate of the second liquid crystal capacitor is electrically connected to the second electrode of the second transistor, and a second plate of the second liquid crystal capacitor is electrically connected to the second common electrode.

In the liquid crystal display panel, a first electrode of the first transistor is electrically connected to the data line, a first electrode of the second electrode is electrically connected to the data line, and the first electrode of the first transistor is electrically connected to the first electrode of the second transistor.

In the liquid crystal display panel, the main sub-pixel unit comprises four domains and the subsidiary sub-pixel unit comprises four domains.

The present invention provides a pixel driving circuit and an LCD panel. The pixel driving circuit comprises a plurality of scan lines and a plurality of data lines. The plurality of scan lines and the plurality of data lines define a plurality of sub-pixel units. One of the plurality of sub-pixel units connected to a scan line and a data line. The sub-pixel unit comprises: a first common electrode; a main sub-pixel unit, comprising a first transistor, a first storage capacitor and a first liquid crystal capacitor; a subsidiary sub-pixel unit, comprising a second transistor, a second storage capacitor and a second liquid crystal capacitor; a third transistor, having a second electrode electrically connected to a first common electrode; wherein gates of the first transistor, the second transistor and the third transistor are electrically connected to a scan line, an electrode of the first transistor is electrically connected to a first electrode of the second transistor, and a second electrode of the second transistor is electrically connected to a first electrode of the third transistor. The present invention uses the first transistor, the second transistor, and the third transistor to control the main sub-pixel unit and the subsidiary sub-pixel unit. Furthermore, the gates of the first transistor, the second transistor, and the third transistor are all connected to the scan line such that only one scan line is required to control the three transistors. In addition, the second electrode of the third transistor is connected to the first common electrode such that a voltage difference between the main sub-pixel unit and the subsidiary sub-pixel unit could exist when the voltage signal flows through the first transistor, the second transistor, and the third transistor. This voltage difference could reduce the color cast. In addition, because only one scan line is required to control the sub-pixel unit and the number of capacitors is reduced. This increases the aperture rate of the display panel and avoids the parasitic capacitance and thus the display effect is improved.

### BRIEF DESCRIPTION OF THE DRAWINGS

FIG. 1 is a diagram of a conventional pixel driving circuit.

FIG. 2 is a diagram of another conventional pixel driving circuit.

FIG. 3 is a diagram of a pixel driving circuit according to a first embodiment of the present invention.

FIG. 4 is a diagram of a pixel driving circuit according to a second embodiment of the present invention.

FIG. 5 is a diagram of an LCD panel according to an embodiment of the present invention.

### DETAILED DESCRIPTION OF PREFERRED EMBODIMENTS

Embodiments of the present application are illustrated in detail in the accompanying drawings, in which like or similar reference numerals refer to like or similar elements or elements having the same or similar functions throughout the specification. The embodiments described below with reference to the accompanying drawings are exemplary and are intended to be illustrative of the present application, and are not to be construed as limiting the scope of the present application.

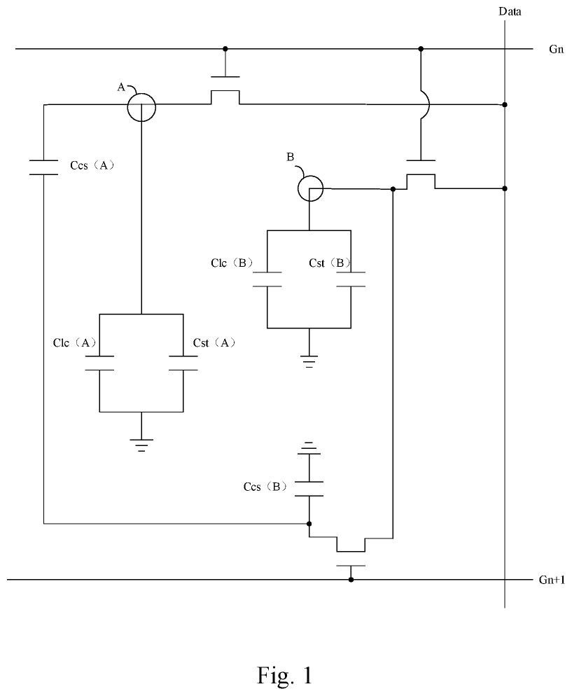

Please refer to FIG. 1. FIG. 1 is a diagram of a conventional pixel driving circuit. The conventional pixel driving circuit comprises a data line Data, an nth scan line Gn, an (n+1)th scan line Gn+1, a main pixel unit A and a subsidiary pixel unit B. From FIG. 1, it can be seen that the assisting capacitor Ccs(A), the liquid crystal (LC) capacitor Clc(A) and the storage capacitor Cst(A) corresponding to the main pixel unit A are all required to drive the main pixel unit A. Furthermore, the assisting capacitor Ccs(B), the LC capacitor Clc(B) and the storage capacitor Cst(B) corresponding to the main pixel unit B are all required to drive the main pixel unit B. In addition, the scan line Gn is required to control the gates of the transistors for driving the pixel unit A. When the scan line Gn controls the transistors to be in the active condition, the liquid crystals of the main pixel unit A rotates to control the polarization of light generated by the backlight module such that the main pixel unit A could show the image. For the subsidiary pixel unit B, the scan line Gn+1 is required to control the gates of the transistors such that the subsidiary pixel unit B could show the image. From FIG. 1, when the main pixel unit and the subsidiary pixel unit are being driven, it could be seen that two scan lines are required to control a complete pixel unit. Furthermore, the assisting capacitor is required to assist the driving circuit to ensure the voltage difference between the main pixel unit A and the subsidiary pixel unit B to avoid the color cast such that the pixel unit could normally work. However, more capacitors might make the entire circuit more unstable. Furthermore, two scan lines means that the aperture rate of the display panel is comparatively small and thus affect the display effect.

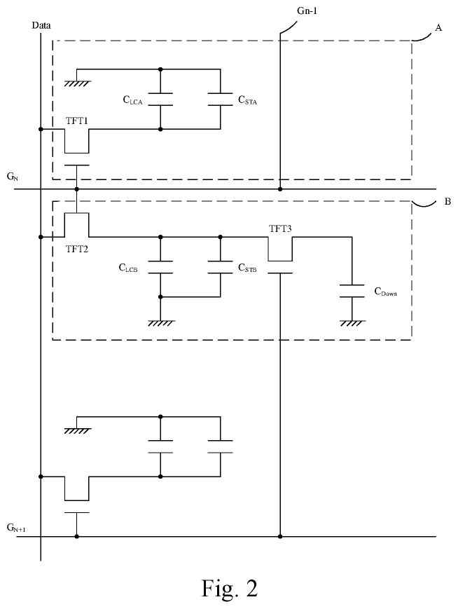

Please refer to FIG. 2. FIG. 2 is a diagram of another conventional pixel driving circuit. As shown in FIG. 2, another conventional pixel driving comprises a data line Data, an nth scan line Gn, an (n+1)th scan line Gn+1, a main pixel unit A and a subsidiary pixel unit B. In FIG. 2, the scan line Gn is used to control the transistor TFT1 such that the transistor TFT1, the liquid crystal capacitor C_{LCA} and the storage capacitor C_{STA} control the main pixel unit A to operate. In addition, the scan line Gn is used to control the transistor TFT2 such that the transistor TFT2, the liquid crystal capacitor C_{LCB} and the storage capacitor C_{STB} control the subsidiary pixel unit B to operate. Furthermore, the scan line Gn+1 is used to control the transistor TFT3 such that the transistor TFT3 and the voltage-reducing capacitor C_{Down} work together to reduce the voltage level of the subsidiary pixel unit B and thus the main pixel unit A and the subsidiary pixel unit B have a voltage difference. In FIG. 2, the label Gn−1 represents that node is electrically connected to Gn−1 but the pixel driving circuit also use two scan lines to control one pixel unit and use the voltage-reducing capacitor to reduce the voltage level of the subsidiary pixel unit. This reduces the aperture rate and affects the display effects. In other words, the conventional display panel has the issue of low aperture rate and low display effect.

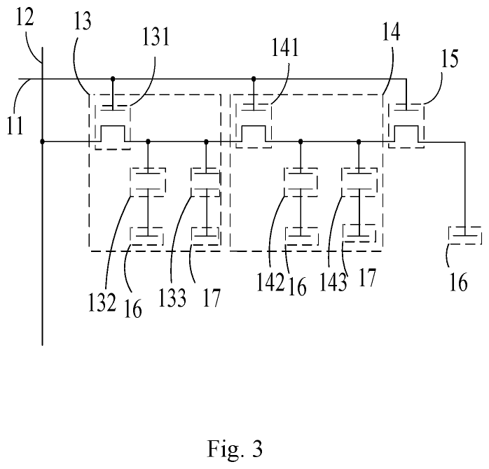

Please refer to FIG. 3. FIG. 3 is a diagram of a pixel driving circuit according to a first embodiment of the present invention. As shown in FIG. 3, the pixel driving circuit comprises a plurality of scan lines 11 and a plurality of data lines. The scan lines 11 and the data lines define a plurality of sub-pixel units. At least one of the sub-pixel units is connected to one scan line 11 and one data line 12.

The sub-pixel unit comprises a first common electrode 16, main sub-pixel unit 13, a sub-pixel unit 14, and a third transistor 15. The main sub-pixel unit 13 comprises a first transistor 131, a first storage capacitor 132 and a first liquid crystal capacitor 133. The subsidiary sub-pixel unit 14 comprises a second transistor 141, a second storage capacitor 142 and a second liquid crystal capacitor 143. The third transistor 15 has a second electrode electrically connected to a first common electrode 16. In this embodiment, gates of the first transistor 131, the second transistor 141 and the third transistor 15 are electrically connected to the scan line 11. An electrode of the first transistor 131 is electrically connected to the first electrode of the second transistor 141. The second electrode of the second transistor 141 is electrically connected to the first electrode of the third transistor 15.

The present invention provides a pixel driving circuit and an LCD panel. The pixel driving circuit comprises a plurality of scan lines and a plurality of data lines. The plurality of scan lines and the plurality of data lines define a plurality of sub-pixel units. One of the plurality of sub-pixel units connected to a scan line and a data line. The sub-pixel unit comprises: a first common electrode; a main sub-pixel unit, comprising a first transistor, a first storage capacitor and a first liquid crystal capacitor; a subsidiary sub-pixel unit, comprising a second transistor, a second storage capacitor and a second liquid crystal capacitor; a third transistor, having a second electrode electrically connected to a first common electrode; wherein gates of the first transistor, the second transistor and the third transistor are electrically connected to a scan line, an electrode of the first transistor is electrically connected to a first electrode of the second transistor, and a second electrode of the second transistor is electrically connected to a first electrode of the third transistor. The present invention uses the first transistor, the second transistor, and the third transistor to control the main sub-pixel unit and the subsidiary sub-pixel unit. Furthermore, the gates of the first transistor, the second transistor, and the third transistor are all connected to the scan line such that only one scan line is required to control the three transistors. In addition, the second electrode of the third transistor is connected to the first common electrode such that a voltage difference between the main sub-pixel unit and the subsidiary sub-pixel unit could exist when the voltage signal flows through the first transistor, the second transistor, and the third transistor. This voltage difference could reduce the color cast. In addition, because only one scan line is required to control the sub-pixel unit and the number of capacitors is reduced. This increases the aperture rate of the display panel and avoids the parasitic capacitance and thus the display effect is improved.

The first electrode of the first transistor 131 is electrically connected to the data line 12. The second electrode of the first transistor 131 is electrically connected to the first electrode of the second transistor 141. Because the first transistor is connected to the data line and the second transistor is connected to the first transistor, the voltage signal transferred from the data line should pass through the first transistor, the second transistor and then the third transistor when the scan line controls the first transistor, the second transistor and the third transistor. This makes the main sub-pixel unit normally operates when the subsidiary sub-pixel unit normally operates. Thus, it ensures that the main sub-pixel unit display images at the same time.

The first transistor 131 and the first storage capacitor 132 are connected in series. The first transistor 131 and the first LC capacitor 133 are connected in series. When the first transistor is turned on, the voltage signal charges the first storage capacitor. During this process, the voltage signal charges the first LC capacitor as well such that the first LC capacitor provides a voltage to rotate the LC molecules of the main sub-pixel unit. Furthermore, the first storage capacitor and the first LC capacitor are connected in parallel and thus the first storage capacitor is charged as well. When the first transistor is turned off, the first storage capacitor and the first LC capacitor is connected in series and thus the first storage capacitor charges the first LC capacitor to keep the voltage level of the first LC capacitor stable. This also keeps the LC molecules stable.

The first plate of the first storage capacitor 132 is electrically connected to the second electrode of the first transistor 131. The second plate of the first storage capacitor 132 is electrically connected to the first common electrode 15. That is, a plate of the first storage capacitor is connected to the second electrode of the first transistor and another plate of the first storage capacitor is connected to the first common electrode such that the voltage signal charges the first storage capacitor after passing through the first transistor.

The pixel driving circuit further comprises a second common electrode 17. The first plate of the first LC capacitor 133 is electrically connected to the second electrode of the first transistor 131. The second plate of the first LC capacitor 133 is electrically connected to the second common electrode 17. The voltage signal charges the first LC capacitor after passing through the first transistor.

The second transistor 141 and the second storage capacitor 143 are connected in series. The second transistor 141 and the second LC capacitor 143 are connected in series. After the voltage signal passes through the second transistor, the voltage signal could charge the second storage capacitor and the second LC capacitor. In addition, because the second storage capacitor and the second LC capacitor are connected in parallel, the charging operation on the second storage capacitor and the charging operation on the second LC capacitor do not affect each other. This makes the voltage levels of the second storage capacitor and the second LC capacitor meet the demands.

The first plate of the second storage capacitor 142 is electrically connected to the second electrode of the second transistor 141. The second plate of the second storage capacitor 142 is electrically connected to the first common electrode 16. Here, a plate of the second storage capacitor is electrically connected to the second electrode of the second transistor such that the voltage signal could reach the second storage capacitor to charge the second storage capacitor after passing through the second transistor. In this way, the second transistor can control the charging of the storage capacitor of the subsidiary sub-pixel unit.

The first plate of the second LC capacitor 143 is electrically connected to the second electrode of the second transistor 141. The second plate of the second LC capacitor 143 is electrically connected to the second common electrode 17. Here, a plate of the second LC capacitor is electrically connected to the second electrode of the second transistor such that the voltage signal could reach the second LC capacitor to charge the second LC capacitor after passing through the second transistor. At this time, the second LC capacitor and the second storage capacitor are connected in parallel. Thus, the second LC capacitor and the second storage capacitor could be respectively charged without affecting each other.

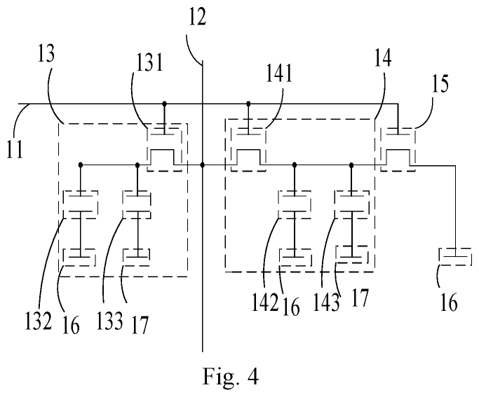

Please refer to FIG. 4. FIG. 4 is a diagram of a pixel driving circuit according to a second embodiment of the present invention. As shown in FIG. 4, the first electrode of the first transistor 131 is electrically connected to the data line 12. The first electrode of the second transistor 141 is electrically connected to the data line 12. The first electrode of the first transistor 131 is electrically connected to the first electrode of the second transistor 141. Here, the first transistor and the second transistor are both electrically connected to the data line. This allows the main sub-pixel unit and the subsidiary sub-pixel unit to be controlled separately such that the main sub-pixel unit and the subsidiary sub-pixel unit do not affect each other. In addition, the second transistor is electrically connected to the third transistor such that the third transistor changes the voltage of the subsidiary sub-pixel unit. In this way, a voltage difference between the main sub-pixel unit and the subsidiary sub-pixel unit exists and thus solves the color cast issue.

In one embodiment, the first electrode is the source and the second electrode is the drain. In another embodiment, the first electrode is the drain and the second electrode is the source.

The sub-pixel unit comprises the main sub-pixel unit and the subsidiary sub-pixel unit. The main sub-pixel unit comprises four domains and the subsidiary sub-pixel unit comprises four domains. However, the number of domains is not a limitation of the present invention. In the actual implementation, the main sub-pixel unit or the subsidiary sub-pixel unit could comprise two domains, four domains or eight domains.

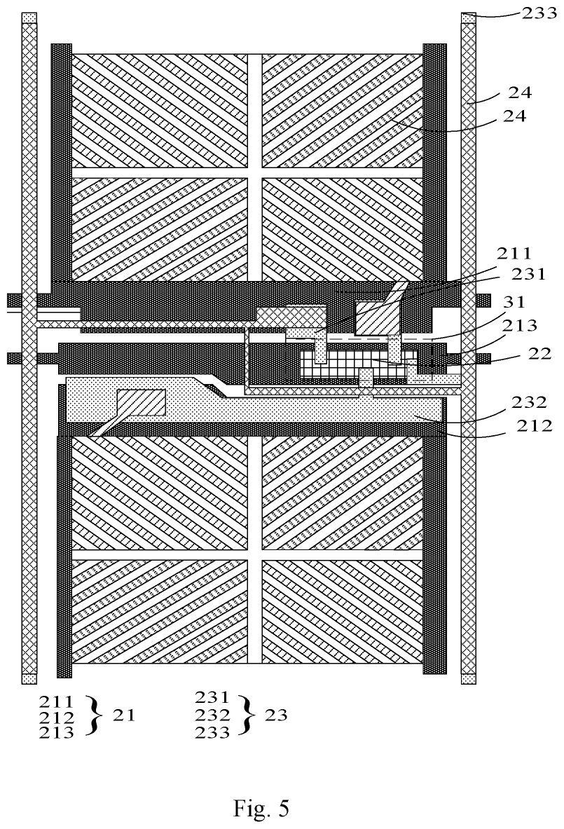

Please refer to FIG. 5. FIG. 5 is a diagram of an LCD panel according to an embodiment of the present invention. As shown in FIG. 5, an LCD panel is disclosed. The LCD panel comprises the above-mentioned pixel driving circuit. The pixel driving circuit comprises a plurality of scan lines and a plurality of data lines. The plurality of scan lines and the plurality of data lines define a plurality of sub-pixel units. One of the plurality of sub-pixel units connected to a scan line and a data line. The sub-pixel unit comprises: a first common electrode; a main sub-pixel unit, comprising a first transistor, a first storage capacitor and a first liquid crystal capacitor; a subsidiary sub-pixel unit, comprising a second transistor, a second storage capacitor and a second liquid crystal capacitor; a third transistor, having a second electrode electrically connected to a first common electrode; wherein gates of the first transistor, the second transistor and the third transistor are electrically connected to a scan line, an electrode of the first transistor is electrically connected to a first electrode of the second transistor, and a second electrode of the second transistor is electrically connected to a first electrode of the third transistor.

The present invention provides an LCD panel. The LCD panel includes a pixel driving circuit. The pixel driving circuit comprises a plurality of scan lines and a plurality of data lines. The plurality of scan lines and the plurality of data lines define a plurality of sub-pixel units. One of the plurality of sub-pixel units connected to a scan line and a data line. The sub-pixel unit comprises: a first common electrode; a main sub-pixel unit, comprising a first transistor, a first storage capacitor and a first liquid crystal capacitor; a subsidiary sub-pixel unit, comprising a second transistor, a second storage capacitor and a second liquid crystal capacitor; a third transistor, having a second electrode electrically connected to a first common electrode; wherein gates of the first transistor, the second transistor and the third transistor are electrically connected to a scan line, an electrode of the first transistor is electrically connected to a first electrode of the second transistor, and a second electrode of the second transistor is electrically connected to a first electrode of the third transistor. The present invention uses the first transistor, the second transistor, and the third transistor to control the main sub-pixel unit and the subsidiary sub-pixel unit. Furthermore, the gates of the first transistor, the second transistor, and the third transistor are all connected to the scan line such that only one scan line is required to control the three transistors. In addition, the second electrode of the third transistor is connected to the first common electrode such that a voltage difference between the main sub-pixel unit and the subsidiary sub-pixel unit could exist when the voltage signal flows through the first transistor, the second transistor, and the third transistor. This voltage difference could reduce the color cast. In addition, because only one scan line is required to control the sub-pixel unit and the number of capacitors is reduced. This increases the aperture rate of the display panel and avoids the parasitic capacitance and thus the display effect is improved.

The LCD panel includes an array substrate, a color filter substrate and a LC layer between the LCD panel array substrate and the color filter substrate. The array substrate comprises a substrate, a first metal layer 21, an active layer 22, a source/drain layer 23, and a pixel electrode layer 24. The color filter substrate comprises a common electrode layer and a color filter layer. The gates of the first transistor, the second transistor and the third transistor are formed by the first metal layer. The first electrode and the second electrode of the first transistor are formed by the source/drain layer. The first electrode and the second electrode of the second transistor are formed by the source/drain layer. The first electrode and the second electrode of the third transistor are formed by the source/drain layer.

In order to more clearly illustrate the first transistor, the second transistor and the third transistor, the label 31 comprises the gates, the first electrodes and the second electrodes of the first transistor, the second transistor and the third transistor. The label 31 comprises the first metal layer portion, the active layer portion and the source/drain layer portion. The source/drain layer portion, from left to right, orderly constitutes the first electrode and the second electrode of the first transistor, the first electrode and the second electrode of the second transistor, and the first electrode and the second electrode of the third transistor. Here, the second electrode of the first transistor and the first electrode of the second transistor share a common portion. The second electrode of the second transistor and the first electrode of the third transistor share a common portion.

The first metal layer 21 forms the scan line 213. The source/drain layer forms the data line 233.

The first plate 231 of the first storage capacitor is formed by the source/drain layer 23. The second plate 211 of the first storage capacitor is formed by the first metal layer 21. The first plate of the first LC capacitor is formed by the pixel electrode layer. The second plate of the first LC capacitor is formed by the common electrode layer on the color filter substrate. The medium of the first LC capacitor is formed by LC molecules. The first plate of the first LC capacitor is electrically connected to the second electrode of the first transistor. That is, a portion of the source/drain layer is electrically connected to a portion of the pixel electrode layer.

The first plate 232 of the second storage capacitor is formed by the source/drain layer 23. The second electrode 212 of the second storage capacitor is formed by the first metal layer 21. The first plate of the second LC capacitor is formed by the pixel electrode layer. The second plate of the second LC capacitor is formed by the common electrode on the color filter substrate. The first plate of the second LC capacitor is electrically connected to the second electrode of the second transistor. That is, a portion of the source/drain layer is electrically connected to a portion of the pixel electrode layer.

The first common electrode is formed by the first metal layer. The first common electrodes electrically connected to the first storage capacitor, the second storage capacitor and the third transistor are different portions of the first metal layer. The above-mentioned first common electrodes have the same voltage level.

The second common electrode is formed by the common electrode layer. The second common electrodes connected to the first LC capacitor, the LC storage capacitor and the third transistor are different portions of the common electrode layer. The first common electrode and the second common electrode have the same voltage level.

In the liquid crystal display panel according to some embodiments, a first electrode of the first transistor is electrically connected to the data line, and a second electrode of the first transistor is electrically connected to the first electrode of the second transistor.

In the liquid crystal display panel according to some embodiments, the first transistor and the first storage capacitor are connected in series, and the first transistor and the first liquid crystal capacitor are connected in series.

In the liquid crystal display panel according to some embodiments, a first plate of the first storage capacitor is electrically connected to the second electrode of the first transistor, and a second plate of the first storage capacitor is electrically connected to the first common electrode.

In the liquid crystal display panel according to some embodiments, the pixel driving circuit further comprises a second common electrode. A first plate of the first liquid crystal capacitor is electrically connected to the second electrode of the first transistor, and a second plate of the first liquid crystal capacitor is electrically connected to the second common electrode.

In the liquid crystal display panel according to some embodiments, the second transistor and the second storage capacitor are connected in series, and the second transistor and the second liquid crystal capacitor are connected in series.

In the liquid crystal display panel according to some embodiments, a first plate of the second storage capacitor is electrically connected to the second electrode of the second transistor, and a second plate of the second storage capacitor is electrically connected to a first common electrode.

In the liquid crystal display panel according to some embodiments, a first plate of the second liquid crystal capacitor is electrically connected to the second electrode of the second transistor, and a second plate of the second liquid crystal capacitor is electrically connected to the second common electrode.

In the liquid crystal display panel according to some embodiments, a first electrode of the first transistor is electrically connected to the data line, a first electrode of the second electrode is electrically connected to the data line, and the first electrode of the first transistor is electrically connected to the first electrode of the second transistor.

In the liquid crystal display panel according to some embodiments, the main sub-pixel unit comprises four domains and the subsidiary sub-pixel unit comprises four domains.

The present invention provides a pixel driving circuit and an LCD panel. The pixel driving circuit comprises a plurality of scan lines and a plurality of data lines. The plurality of scan lines and the plurality of data lines define a plurality of sub-pixel units. One of the plurality of sub-pixel units connected to a scan line and a data line. The sub-pixel unit comprises: a first common electrode; a main sub-pixel unit, comprising a first transistor, a first storage capacitor and a first liquid crystal capacitor; a subsidiary sub-pixel unit, comprising a second transistor, a second storage capacitor and a second liquid crystal capacitor; a third transistor, having a second electrode electrically connected to a first common electrode; wherein gates of the first transistor, the second transistor and the third transistor are electrically connected to a scan line, an electrode of the first transistor is electrically connected to a first electrode of the second transistor, and a second electrode of the second transistor is electrically connected to a first electrode of the third transistor. The present invention uses the first transistor, the second transistor, and the third transistor to control the main sub-pixel unit and the subsidiary sub-pixel unit. Furthermore, the gates of the first transistor, the second transistor, and the third transistor are all connected to the scan line such that only one scan line is required to control the three transistors. In addition, the second electrode of the third transistor is connected to the first common electrode such that a voltage difference between the main sub-pixel unit and the subsidiary sub-pixel unit could exist when the voltage signal flows through the first transistor, the second transistor, and the third transistor. This voltage difference could reduce the color cast. In addition, because only one scan line is required to control the sub-pixel unit and the number of capacitors is reduced. This increases the aperture rate of the display panel and avoids the parasitic capacitance and thus the display effect is improved.

Above are embodiments of the present invention, which does not limit the scope of the present invention. Any modifications, equivalent replacements or improvements within the spirit and principles of the embodiment described above should be covered by the protected scope of the invention.

What is claimed is:

1. A pixel driving circuit comprising a plurality of scan lines and a plurality of data lines, the plurality of scan lines and the plurality of data lines defining a plurality of sub-pixel units, one of the plurality of sub-pixel units connected to a scan line and a data line, and the sub-pixel unit comprising:
a first common electrode;
a main sub-pixel unit, comprising a first transistor, a first storage capacitor and a first liquid crystal capacitor;
a subsidiary sub-pixel unit, comprising a second transistor, a second storage capacitor and a second liquid crystal capacitor;
a third transistor, having a second electrode electrically connected to a first common electrode;
wherein gates of the first transistor, the second transistor and the third transistor are electrically connected to a scan line, an electrode of the first transistor is electrically connected to a first electrode of the second transistor, and a second electrode of the second transistor is electrically connected to a first electrode of the third transistor.

2. The pixel driving circuit of claim 1, wherein a first electrode of the first transistor is electrically connected to the data line, and a second electrode of the first transistor is electrically connected to the first electrode of the second transistor.

3. The pixel driving circuit of claim 2, wherein the first transistor and the first storage capacitor are connected in series, and the first transistor and the first liquid crystal capacitor are connected in series.

4. The pixel driving circuit of claim 3, wherein a first plate of the first storage capacitor is electrically connected to the second electrode of the first transistor, and a second plate of the first storage capacitor is electrically connected to the first common electrode.

5. The pixel driving circuit of claim 4, further comprising a second common electrode, wherein a first plate of the first liquid crystal capacitor is electrically connected to the second electrode of the first transistor, and a second plate of the first liquid crystal capacitor is electrically connected to the second common electrode.

6. The pixel driving circuit of claim 5, wherein the second transistor and the second storage capacitor are connected in series, and the second transistor and the second liquid crystal capacitor are connected in series.

7. The pixel driving circuit of claim 6, wherein a first plate of the second storage capacitor is electrically connected to the second electrode of the second transistor, and a second plate of the second storage capacitor is electrically connected to a first common electrode.

8. The pixel driving circuit of claim 7, wherein a first plate of the second liquid crystal capacitor is electrically connected to the second electrode of the second transistor, and a second plate of the second liquid crystal capacitor is electrically connected to the second common electrode.

9. The pixel driving circuit of claim 1, wherein a first electrode of the first transistor is electrically connected to the data line, a first electrode of the second electrode is electrically connected to the data line, and the first electrode of the first transistor is electrically connected to the first electrode of the second transistor.

10. The pixel driving circuit of claim 1, wherein the main sub-pixel unit comprises four domains and the subsidiary sub-pixel unit comprises four domains.

11. A liquid crystal display panel comprising a pixel driving circuit, the pixel driving circuit comprising a plurality of scan lines and a plurality of data lines, the plurality of scan lines and the plurality of data lines defining a plurality of sub-pixel units, one of the plurality of sub-pixel units connected to a scan line and a data line, and the sub-pixel unit comprising:
a first common electrode;
a main sub-pixel unit, comprising a first transistor, a first storage capacitor and a first liquid crystal capacitor;
a subsidiary sub-pixel unit, comprising a second transistor, a second storage capacitor and a second liquid crystal capacitor;
a third transistor, having a second electrode electrically connected to a first common electrode;
wherein gates of the first transistor, the second transistor and the third transistor are electrically connected to a scan line, an electrode of the first transistor is electrically connected to a first electrode of the second transistor, and a second electrode of the second transistor is electrically connected to a first electrode of the third transistor.

12. The liquid crystal display panel of claim 11, wherein a first electrode of the first transistor is electrically connected to the data line, and a second electrode of the first transistor is electrically connected to the first electrode of the second transistor.

13. The liquid crystal display panel of claim 12, wherein the first transistor and the first storage capacitor are connected in series, and the first transistor and the first liquid crystal capacitor are connected in series.

14. The liquid crystal display panel of claim 13, wherein a first plate of the first storage capacitor is electrically connected to the second electrode of the first transistor, and a second plate of the first storage capacitor is electrically connected to the first common electrode.

15. The liquid crystal display panel of claim 14, wherein the pixel driving circuit further comprises a second common electrode, wherein a first plate of the first liquid crystal capacitor is electrically connected to the second electrode of the first transistor, and a second plate of the first liquid crystal capacitor is electrically connected to the second common electrode.

16. The liquid crystal display panel of claim 15, wherein the second transistor and the second storage capacitor are connected in series, and the second transistor and the second liquid crystal capacitor are connected in series.

17. The liquid crystal display panel of claim 16, wherein a first plate of the second storage capacitor is electrically connected to the second electrode of the second transistor, and a second plate of the second storage capacitor is electrically connected to a first common electrode.

18. The liquid crystal display panel of claim 17, wherein a first plate of the second liquid crystal capacitor is electrically connected to the second electrode of the second transistor, and a second plate of the second liquid crystal capacitor is electrically connected to the second common electrode.

19. The liquid crystal display panel of claim 11, wherein a first electrode of the first transistor is electrically connected to the data line, a first electrode of the second electrode is electrically connected to the data line, and the first electrode of the first transistor is electrically connected to the first electrode of the second transistor.

20. The liquid crystal display panel of claim 11, wherein the main sub-pixel unit comprises four domains and the subsidiary sub-pixel unit comprises four domains.
